(19) United States
(12) Patent Application Publication
(10) Pub. No.: US 2026/0175439 A1
(43) Pub. Date: Jun. 25, 2026

(54) ROBOTIC FAUCET

(71) Applicant: KTIO LLC, Coeur d'Alene, ID (US)

(72) Inventors: Kenneth TYLER, Coeur d'Alene, ID (US); Patrick L. TYLER, Coeur d'Alene, ID (US)

(21) Appl. No.: 19/430,454

(22) Filed: Dec. 23, 2025

Related U.S. Application Data
(60) Provisional application No. 63/737,893, filed on Dec. 23, 2024.

(51) Int. Cl. B25J 11/00; A46B 13/02; A47L 15/00; A47L 15/39; A47L 15/42; A47L 15/44; A47L 15/46; B25J 9/16; B25J 13/00; B25J 15/00; E03C 1/05; G05D 23/19

(52) U.S. Cl. CPC B25J 11/0085; A46B 13/02; A47L 15/0086; A47L 15/39; A47L 15/4217; A47L 15/4295; A47L 15/4418; A47L 15/46; B25J 9/1676; B25J 9/1682; B25J 13/003; B25J 15/0019; E03C 1/057; G05D 23/1917; A46B 2200/3033; G05B 2219/39001

(57) ABSTRACT

A robotic faucet that serves as both a faucet, such as a kitchen sink faucet, and a robotic dishware cleaner.

### CROSS-REFERENCE TO RELATED APPLICATIONS

This application claims the benefit of U.S. Provisional Application No. 63/737,893 filed Dec. 23, 2024, which is incorporated herein by reference in its entirety.

### TECHNICAL FIELD

These teachings relate generally to faucets and more particularly to kitchen faucets.

### BACKGROUND

Faucets typically include hand-manipulated valves that control a local flow of water through a directed pipe. More particularly, a faucet is a device designed to control a flow of liquid, typically water, from a pipe or plumbing system. Faucets consist of a spout, one or two hand-manipulated handles that control one or more corresponding valves that regulate flow (and often the temperature) of the liquid.

A kitchen, both domestic and industrial, will typically include one or more faucets, usually located at a corresponding sink(s). The flow of water can be directed into the sink and can serve to facilitate, for example, washing hands and/or dishware (where “dishware” will be understood to refer to any and all food preparation, storage, serving, or eating implements including but not limited to pots, pans, dishes, saucers, bowls, glasses, cups, utensils, and so forth).

Many application settings also include one or more automatic dishwashers. The latter typically comprise a large box-like appliance that is installed under the counter and that utilizes water and a detergent to expose dishware to a cleaning cycle. While offering a certain level of convenience, such dishwashers also impose corresponding tasks on the user, such as at least partially clearing food debris off of plates and properly placing the soiled dishware into the dishwasher.

### BRIEF DESCRIPTION OF DRAWINGS

Various are at least partially met through provision of the robotic faucet described in the following detailed description, particularly when studied in conjunction with the drawings, wherein:

FIG. 1 comprises a block diagram as configured in accordance with various embodiments of these teachings;

FIG. 2 comprises a perspective view as configured in accordance with various embodiments of these teachings; and

FIG. 3 comprises a perspective view as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, pursuant to these various embodiments a robotic faucet includes at least one articulated robotic arm. The robotic arm can be controlled to wash dishware in a corresponding sink or container. The robotic faucet can be configured to also control a flow of water (and the temperature of that water) to facilitate such washing. The robotic faucet can include one or more user interfaces, one or more actuators and end effectors, one or more valves, and/or one or more sensors as desired.

In some aspects, the techniques described herein relate to an apparatus for use with a faucet that is configured to be installed in operable proximity to a sink and to dispense water with user-controlled water flow and water temperature, the apparatus including: a control circuit that is configured to operably couple to at least one water flow valve for the faucet to thereby permit the control circuit to automatically control at least one flow of water through the faucet; at least one articulated robotic arm that is configured to be physically connected at a first end proximal to the sink and that has an end effector connector disposed at a second end of the at least one articulated robotic arm, which second end is opposite the first end, and wherein the at least one articulated robotic arm is operably coupled to the control circuit such that the control circuit automatically controls operation of the at least one articulated robotic arm; at least one sensor that operably couples to the control circuit, which at least one sensor is configured to sense at least one physical parameter; and wherein the control circuit is further configured to use the at least one water flow valve, the at least one articulated robotic arm, and the at least one sensor to automatically wash dishware in the sink.

In some aspects, the techniques described herein relate to an apparatus wherein the control circuit is configured to operably couple to at least a cold water flow valve for the faucet and to at least a hot water flow value to thereby permit the control circuit to automatically control a temperature of water flowing through the faucet.

In some aspects, the techniques described herein relate to an apparatus further including at least one first end effector that is configured to selectively and operably temporarily mate to the end effector connector.

In some aspects, the techniques described herein relate to an apparatus wherein the at least one first end effector includes a scrub brush.

In some aspects, the techniques described herein relate to an apparatus wherein the scrub brush includes a spinning scrub brush.

In some aspects, the techniques described herein relate to an apparatus wherein the at least one physical parameter includes at least one of: a temperature; a liquid flow parameter; a movement; audible content; moisture; visual content; a tactile parameter.

In some aspects, the techniques described herein relate to an apparatus wherein the control circuit is further configured to, upon detecting an animal presence within a selected proximity range of the apparatus, automatically halt dishware washing.

In some aspects, the techniques described herein relate to an apparatus wherein the control circuit is further configured to, upon detecting an animal presence within a selected proximity range of the apparatus, automatically retract the at least one articulated robotic arm to a predetermined pause pose.

In some aspects, the techniques described herein relate to an apparatus further including: at least a second articulated robotic arm that is configured to be physically connected at a first end proximal to the sink and that has an end effector connector disposed at a second end of the at least second articulated robotic arm, which second end is opposite the first end, and wherein the at least second articulated robotic arm is operably coupled to the control circuit such that the control circuit automatically controls operation of the at least second articulated robotic arm.

In some aspects, the techniques described herein relate to an apparatus wherein: the end effector connector of the first articulated robotic arm is operably connected to a gripping effector that the control circuit is configured to employ to grip dishware to be washed; the end effector connector of the second articulated robotic arm is operably connected to a scrubbing effector that the control circuit is configured to employ to wash dishware that is gripped by the gripping effector.

In some aspects, the techniques described herein relate to an apparatus wherein the second articulated robotic arm has a different number of articulated joints than the first articulated robotic arm.

In some aspects, the techniques described herein relate to an apparatus further including: a fluid dispenser operably coupled to the control circuit and configured to retain a fluid in a corresponding container, such that the control circuit can selectively cause the fluid to be dispensed from the corresponding container.

In some aspects, the techniques described herein relate to an apparatus wherein the fluid includes a detergent.

In some aspects, the techniques described herein relate to an apparatus wherein the fluid includes a rinsing agent.

In some aspects, the techniques described herein relate to an apparatus further including: a user interface operably coupled to the control circuit.

In some aspects, the techniques described herein relate to an apparatus wherein the control circuit is configured to respond to at least some voice commands uttered by a user via the user interface.

In some aspects, the techniques described herein relate to an apparatus wherein the control circuit is configured to detect, via the at least one sensor, a presence of dishware in the sink.

In some aspects, the techniques described herein relate to an apparatus wherein the control circuit is further configured to, upon detecting at least a requisite quantity of the dishware in the sink, automatically employ the at least one articulated robotic arm to wash at least some of the dishware in the sink.

In some aspects, the techniques described herein relate to an apparatus further including: a plurality of different end effectors; and wherein the control circuit is further configured to automatically select a particular one of the plurality of different end effectors and attach the selected end effector to the end effector connector.

In some aspects, the techniques described herein relate to an apparatus wherein the control circuit is further configured to use the at least one articulated robotic arm to automatically place washed dishware in a drying area.

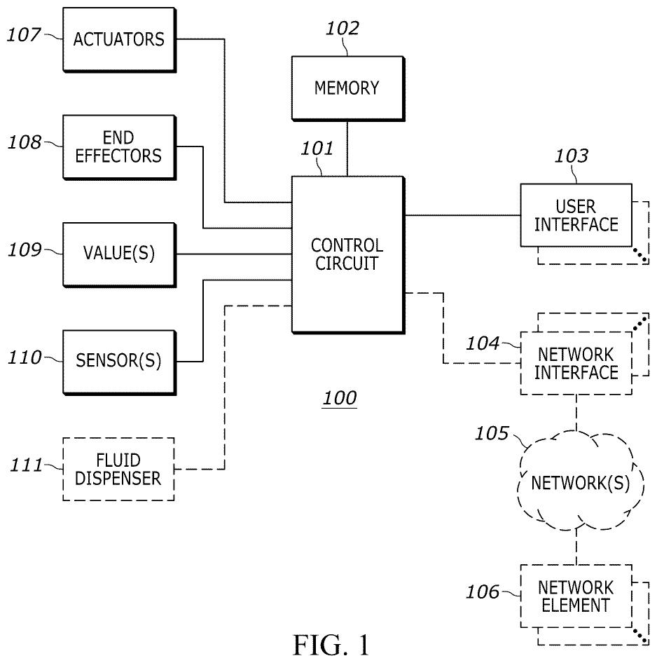

Various benefits may become clearer upon making a thorough review and study of the following detailed description. Referring now to the drawings, and in particular to FIG. 1, an illustrative apparatus 100 that is compatible with many of these teachings will first be presented.

In this particular example, the enabling apparatus 100 includes a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

It will be appreciated that the control circuit 101 may comprise a single integrated platform or may comprise a plurality of such circuits that work in cooperation with one another.

The control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101). As with the control circuit 101, the memory 102 may comprise a singular structure or may comprise a plurality of memory platforms that collectively comprise the “memory” of this apparatus 100.

This memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as a dynamic random access memory (DRAM).)

The control circuit 101 also operably couples to at least one user interface 103. This user interface 103 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

If desired the control circuit 101 can also operably couple to one or more network interfaces 104 (such as a Wi-Fi® interface, a Bluetooth® interface, a cellular telephony interface, and so forth). So configured, the control circuit 101 can communicate with other networks elements 106 (both within the apparatus 100 and external thereto) via one or more intervening networks 105.

The control circuit 101 can also operably couple to, and receive information from and/or provide controlling signals to, a variety of other elements.

As a first example in these regards, the control circuit 101 can operably couple to one or more actuators 107. In a typical application setting, these actuators can include movement and directional actuators in robot arms. Such actuators can serve to convert energy into motion, allowing the robotic arm to perform tasks such as washing dishware in a sink. These teachings will accommodate any of a variety of actuator types, including but not limited to actuators that are powered by air, electricity, or liquids.

As a next example in these regards, the control circuit 101 can operably couple to one or more end effectors 108. In a general sense, end effectors enable robots to handle, manipulate, and/or sense objects. These end effectors may be configured to attached (permanently or temporarily as desired) to the aforementioned robotic arm(s) and to serve as tools to perform particular tasks (pertaining, for example, to cleaning dishware).

As a next example in these regards, the control circuit 101 can operably couple to one or more valves, and in particular, water valves. Such a valve can be electrically controlled by the control circuit 101. By one approach, one or more of these valves can be selectively moved through a range of opening settings, to thereby permit a nuanced control of the flow of water there through. In one application setting, the control circuit 101 controls a first valve that controls a flow of cold water and a second valve that controls a flow of hot water from a hot water source.

As another example in these regards, the control circuit 101 can operably couple to one or more sensors 110. These teachings will accommodate any of a wide variety of sensors. A non-exclusive listing in these regards can include tactile sensors, heat sensors, water flow sensors, cameras, motion sensors, audio sensors (such as microphones), touch sensors, moisture sensors, and chemical/odor sensors, to note but a few.

As yet another example in these regards, the control circuit 101 can operably couple to a fluid dispenser 111 to control the dispensing of, for example, one or more cleaning fluids or rinse fluids.

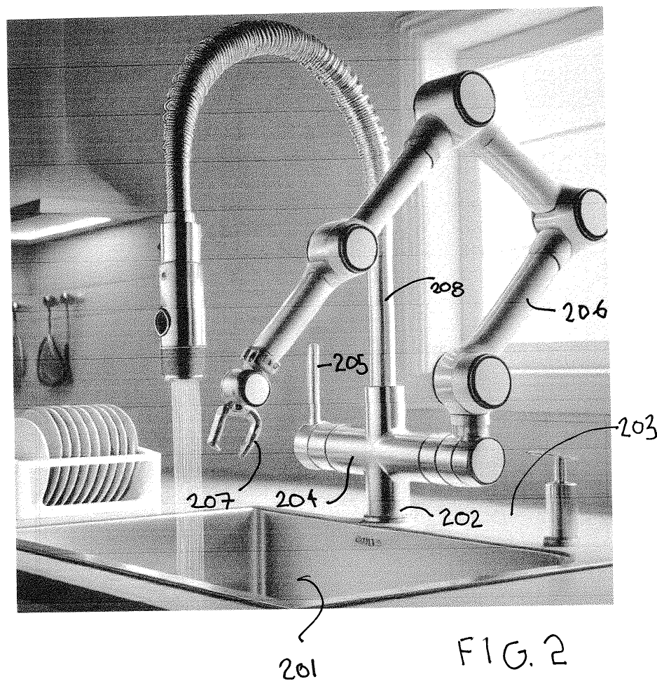

FIG. 2 presents one approach that accords with these teachings. In this example, a robotic faucet is placed at a residential kitchen sink 201. The robotic faucet has a base 202 that secures in an ordinary manner atop a countertop 203. The base 202 connects to a horizontal member 204 that supports both a handle 205 by which a human operator can control a flow of water through the faucet and a robotic arm 206.

In this example the robotic arm 206 includes four arm segments that each attach to one another (and to the horizontal member 204 at one end and an end effector 108 comprising a gripping tool 207 at the opposing end) via articulation joints. The number of degrees of freedom offered at these various articulation joints can vary with the needs of the application setting or as otherwise desired.

A spout assembly 208 rises up from the horizontal member 204.

So configured, and depending upon the actuators 107, end effectors 108, valves 109, and sensors 100 provided, the aforementioned control circuit 101 (which may be located within the robotic faucet assembly or which may be located elsewhere, such as beneath the aforementioned countertop 203) can utilize the robotic arm 206 and a controlled flow of water to manipulate items to be rinsed or washed.

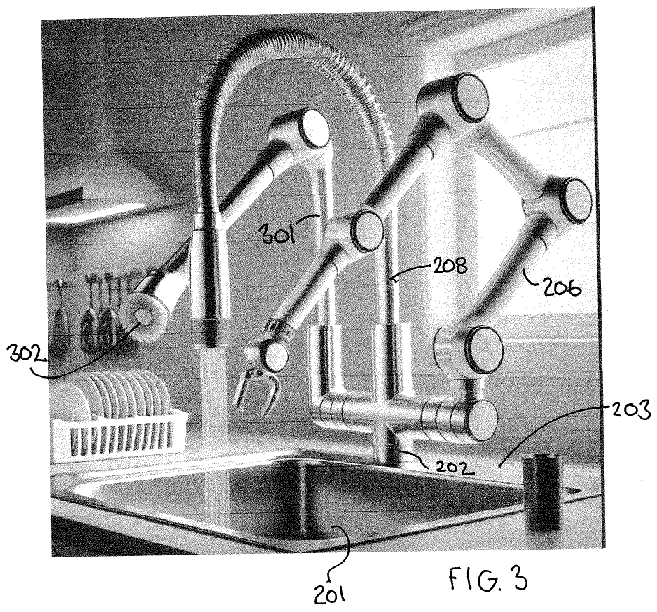

FIG. 3 presents a modified version of the above-described robotic faucet. In this example, the robotic faucet includes a second robotic arm 301. In this example, the second robotic arm 301 has fewer arm segments than the first robotic arm 206. And in this example, the second robotic arm 301 includes an end effector 108 comprising a spinning scrub brush 302. So configured, the robotic faucet can hold an item to be washed with the first robotic arm 206 and remove debris and otherwise abrade the item using the spinning scrub brush 302.

So configured, these teachings provide a robotic that seamlessly integrates robotic arms and cleaning mechanisms into the standard form factor of a kitchen faucet. This apparatus can be designed to attach to a sink like a conventional faucet, with robotic controls and actuators located both above and below the sink. The system can transform from an automated robotic unit for cleaning dishes into a standard faucet when not in use, ensuring user familiarity and comfort.

Generally speaking, these teachings can provide for a robotic faucet having a central faucet arm (that functions as a traditional faucet, dispensing water with user-controlled flow and temperature) that can be equipped with sensors, cameras, and communication devices to interact with users and detect the presence of dishes and utensils, a first robotic arm (that can be equipped with a grabber end effector featuring rubber grippers and that can be responsible for manipulating and handling kitchen items such as dishes, utensils, and cookware), and a second robotic arm (that when fitted with cleaning tools such as scrubbers, brushes, or scrapers, this arm can perform the cleaning and scrubbing tasks that facilitate washing dishes).

The control circuit 101 can utilize or itself comprise an artificial intelligence (AI) module, machine vision, and various sensors to detect human presence, identify kitchen items, and perform cleaning tasks autonomously. Safety features can include lasers, proximity sensors, and emergency stop mechanisms that halt robotic operations when a person or object (such as a pet) enters the active zone.

Activation of the robotic functions can occur through various user inputs, including touch, voice commands, hand gestures, facial recognition, or other emotes. When a user approaches the sink, the robotic faucet can, by one approach, quickly revert to a home position, thereafter functioning as a standard faucet to allow for normal kitchen use.

Further details that comport with these teachings will now be presented. It will be understood that the specific details of these examples are intended to serve an illustrative purpose and are not intended to suggest any particular limitations with respect to these teachings.

### Analog Lever Controls

The robotic faucet may include one or more traditional faucet levers or handles, allowing a user to manually control water flow and temperature as they would with a standard faucet. This ensures familiarity, easy use, and peace of mind for those hesitant to engage advanced features.

### Motion Sensors and Proximity Detection

Integrated motion sensors can allow users to activate water flow by simply placing their hands or items beneath the faucet. Gestures can trigger the robotic faucet to dispense water, adjust temperature, or initiate simple cleaning tasks without direct physical contact.

### Voice Commands

The robotic faucet can include one or more microphones and natural language processing to recognize voice commands. Users can say, for example, “Start hot water,” “Clean this glass,” or “Pause,” enabling hands-free operation. Voice cues can also instruct an artificial intelligence to switch tools, adjust cleaning cycles, or engage drying functions.

### Facial, Eye, and Emoticon Gestures

Advanced cameras and AI-driven facial recognition can allow user to communicate non-verbally. A simple smile or nod might tell the robotic faucet to start a routine, while a raised eyebrow or a designated gesture may cancel an ongoing task. Emoticon-like gestures or icons displayed on a small interface panel can also serve as intuitive interaction cues for the user.

### Tactile and Touch Inputs

Touch-sensitive panels or capacitive touch zones on the faucet body can enable users to select modes, scroll through settings, or confirm selections with a finger tap. This creates a versatile interface for users who prefer direct contact.

### AI Input and Sensing Modalities

### Camera and Vision Systems

High-resolution cameras combined with computer vision algorithms can allow an AI module to identify dish types, recognize dirty versus clean surfaces, and distinguish organic from non-organic debris. The cameras can also monitor hand gestures, facial expressions, and overall kitchen environment safety.

### Sound and Microphones

In addition to voice commands, the system can pick up ambient sounds, detect changes in kitchen activity, and respond accordingly.

For example, the sound of a plate being placed in the sink might prompt the system to ask if the user would like it cleaned.

### Pressure and Force Sensors

Tactile sensors in the robotic arm and grippers can ensure proper handling of fragile glassware and sensitive utensils. These sensors can gauge the force needed to pick up items without causing breakage or slipping.

### Thermal and Moisture Sensors

Temperature sensors can allow precise water heating, cooling, and maintenance of safe temperatures for humans while enabling higher temperatures for robotic cleaning cycles. Moisture sensors help monitor the dryness of cleaned items and prevent water wastage.

### Chemical and Odor Sensors

Advanced versions can integrate sensors to detect cleaning fluid concentrations or even recognize certain odors that might indicate spoiled food, guiding waste disposal decisions.

### Changeable Tools and Cleaning Accessories

### Interchangeable End Effectors

The robotic arm can be configured to accept a variety of end effectors designed for specific cleaning tasks, such as:
Scrapers: For removing tough, stuck-on food residue.
Whiskers/Soft Brushes: Delicate bristle tools for gentle cleaning of fragile glassware or stemware.
Sponges and Pads: For general-purpose cleaning of plates, bowls, and cookware.

A small tool bay located beneath the sink or within a nearby cabinet could store these tools. The control circuit 101 can be configured to automatically exchange them based on the item and cleaning cycle selected by, for example, an AI module.

### Automated Soap and Fluid Dispenser

The faucet apparatus can integrate multiple cleaning agents, soaps, and sanitizing fluids. The system can precisely measure and mix these agents with water, adjusting concentration and delivery timing to optimize cleaning. For fragile glassware, it might use milder soap and lower water pressure; for heavily soiled cookware, a stronger soap and higher pressure might be applied.

### Multi-Basin and Water Management

### Utilizing a Full Sink Basin

If one side of a dual-basin sink is filled with warm, soapy water, the robotic faucet can carefully submerge and soak dishes to loosen debris before scrubbing. An AI module can monitor the soak time and recommend switching to a scrubbing cycle when appropriate.

### Water Level Monitoring and Overflow Prevention

Pressure and float sensors can monitor the water level in a sink. If the water rises too high, the control circuit 101 can automatically pause inlet water flow and may engage a drain or adjust the task sequence to prevent overflow. This can help to ensure a safe and controlled cleaning environment.

### Temperature and Sanitation Control

Humans often prefer lukewarm or comfortably warm water, while higher temperatures are more effective for cleaning and sanitizing. The robotic faucet can distinguish between human-use mode and robotic cleaning mode, thus providing cooler water for manual rinsing and much hotter water during an automated cleaning cycle. Safety interlocks can prevent scalding water from dispensing when a human hand is detected.

### Waste Disposal and Garbage Management

### Basic Disposal Methods

By one approach, the robotic arm can scrape or brush food scraps off a plate into a small container or bin placed within the sink area. A user can then remove the container and empty it into a trash receptacle. This approach keeps initial setup simple while still providing convenience.

### Automated Disposal Options

More advanced configurations can allow the robotic arm to transfer food scraps directly into a built-in receptacle, trash compactor, or waste chute integrated into the countertop. The system might also route organic waste into a composting unit or direct small debris toward a garbage disposal unit under the sink.

### Interaction with Garbage Disposal

When organic material is detected (via vision or chemical sensors), and the user permits, the system can run the garbage disposal to flush out waste. The control circuit 101 can ensure that utensils or non-organic debris are not present before activation. If small bits of food remain on a plate, the arm can hold the plate under running water, guiding the scraps into the disposal opening.

### Material Recognition and Sorting

The vision system can help to facilitate distinguishing organic waste, recyclable materials like glass or plastic, and general trash. This allows it to alert users if a non-organic item ends up in the sink. Such recognition capabilities assist in proper waste management and environmental stewardship.

### Safety and Fail-Safe Mechanisms

### Manual Override

A simple switch or lever can allow users to revert the faucet to a fully manual mode, disabling all robotic and AI functions. This can help to ensure that if the system malfunctions or loses power, humans can still access water as needed.

### Emergency Stop Functions

Easily accessible buttons or voice commands (“Emergency Stop”) can facilitate immediately ceasing all robotic activity. This can help to prevent potential conflict with other items in the vicinity.

### System Diagnostics and Alerts

The control circuit 101 can be configured to detect mechanical or software anomalies. If performance issues occur, it can notify the user through visual or audio alerts. Maintenance instructions can be displayed on a small screen or sent to the user's phone or connected devices.

### Connectivity and Integration With Other Smart Devices

### Communication With AI Home Systems

The control circuit 101 can integrate with home or commercial building systems, such as voice assistants, smart speakers, or central kitchen hubs. It can share data and receives instructions for overall kitchen or household management. By one approach, for example, the control circuit 101 can negotiate or otherwise accommodate other appliances or systems that might also be using (or are scheduled to use) hot water resources to avoid unduly stressing the hot water source.

### Coordination With Humanoid Robots

The robotic faucet may coordinate with other robots, including humanoid robots. For instance, a humanoid kitchen assistant might place dirty dishes in the sink area, prompting the control circuit 101 to initiate a cleaning cycle automatically.

### Smart Appliances and Sensors

The robotic faucet can be configured to communicate with dish storage units, inventory management systems, refrigerators, and vacuum cleaners. For example, after cleaning, it might signal a smart dish cabinet to open so the cleaned items can be stored, or alert a vacuum robot to clean the floor around the sink area.

### Advanced Water Temperature and Pressure Controls

### Voice-Activated Temperature Control

Users can say “Make the water warmer” or “Cool down the rinse,” and the system can respond instantly, mixing hot and cold water to achieve the desired temperature.

### Higher Temperatures for Cleaning Mode

When in robotic cleaning mode, the system might use near-boiling water to sanitize glassware thoroughly, then safely return to a cooler setting once a human presence is detected.

### Dynamic Pressure Adjustment

Pressure control can ensure a gentle flow for delicate items and a more forceful spray for tough cleaning tasks, all adjustable by voice, gesture, or preset program.

These teachings will accommodate using the robotic faucet in conjunction with any of a variety of ancillary items. Examples include:

Robotic faucet drying rack: An accessory designed to work with the robotic faucet for drying and organizing cleaned dishes. The control circuit can be configured to automatically place washed dishware items in the drying rack. By one approach, the drying rack can implement a selected disinfectant capability, such as exposing the dishware to ultraviolet light and/or to suitably heated air.

Robotic faucet kitchen communications hub and system: A centralized system for coordinating the robotic faucet's operations with other smart kitchen appliances and devices.

Robotic faucet dishes and utensils: Kitchenware integrated with near-field communication (NFC) chips or other identifiers (such as bar codes or the like) for easy recognition.

Robotic faucet dish drawer: A storage solution that automatically receives and stores cleaned items from the robotic faucet.

Robotic faucet sensors and NFC chips: Components that enhance the system's ability to identify and interact with kitchen items.

Robotic faucet kitchen communications platform: Software and networking solutions that connect the robotic faucet to a broader smart home ecosystem.

These teachings can support transforming a kitchen faucet into an intelligent, adaptive hub for cleaning, waste management, and broader smart home integration. From multiple input methods and changeable cleaning tools, to advanced fluid and temperature control, soaking and water level monitoring, and various waste disposal strategies, the robotic faucet is envisioned as a comprehensive solution that elevates both convenience and efficiency in modern kitchen environments.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. An apparatus for use with a faucet that is configured to be installed in operable proximity to a sink and to dispense water with user-controlled water flow and water temperature, the apparatus comprising:
a control circuit that is configured to operably couple to at least one water flow valve for the faucet to thereby permit the control circuit to automatically control at least one flow of water through the faucet;
at least one articulated robotic arm that is configured to be physically connected at a first end proximal to the sink and that has an end effector connector disposed at a second end of the at least one articulated robotic arm, which second end is opposite the first end, and wherein the at least one articulated robotic arm is operably coupled to the control circuit such that the control circuit automatically controls operation of the at least one articulated robotic arm;
at least one sensor that operably couples to the control circuit, which at least one sensor is configured to sense at least one physical parameter; and wherein the control circuit is further configured to use the at least one water flow valve, the at least one articulated robotic arm, and the at least one sensor to automatically wash dishware in the sink.

2. The apparatus of claim 1 wherein the control circuit is configured to operably couple to at least a cold water flow valve for the faucet and to at least a hot water flow value to thereby permit the control circuit to automatically control a temperature of water flowing through the faucet.

3. The apparatus of claim 1 further comprising at least one first end effector that is configured to selectively and operably temporarily mate to the end effector connector.

4. The apparatus of claim 3 wherein the at least one first end effector comprises a scrub brush.

5. The apparatus of claim 4 wherein the scrub brush comprises a spinning scrub brush.

6. The apparatus of claim 1 wherein the at least one physical parameter comprises at least one of:
a temperature;
a liquid flow parameter;
a movement;
audible content;
moisture;
visual content;
a tactile parameter.

7. The apparatus of claim 1 wherein the control circuit is further configured to, upon detecting an animal presence within a selected proximity range of the apparatus, automatically halt dishware washing.

8. The apparatus of claim 7 wherein the control circuit is further configured to, upon detecting an animal presence within a selected proximity range of the apparatus, automatically retract the at least one articulated robotic arm to a predetermined pause pose.

9. The apparatus of claim 1 further comprising:
at least a second articulated robotic arm that is configured to be physically connected at a first end proximal to the sink and that has an end effector connector disposed at a second end of the at least second articulated robotic arm, which second end is opposite the first end, and wherein the at least second articulated robotic arm is operably coupled to the control circuit such that the control circuit automatically controls operation of the at least second articulated robotic arm.

10. The apparatus of claim 9 wherein:
the end effector connector of the first articulated robotic arm is operably connected to a gripping effector that the control circuit is configured to employ to grip dishware to be washed;
the end effector connector of the second articulated robotic arm is operably connected to a scrubbing effector that the control circuit is configured to employ to wash dishware that is gripped by the gripping effector.

11. The apparatus of claim 9 wherein the second articulated robotic arm has a different number of articulated joints than the first articulated robotic arm.

12. The apparatus of claim 1 further comprising:
a fluid dispenser operably coupled to the control circuit and configured to retain a fluid in a corresponding container, such that the control circuit can selectively cause the fluid to be dispensed from the corresponding container.

13. The apparatus of claim 12 wherein the fluid comprises a detergent.

14. The apparatus of claim 12 wherein the fluid comprises a rinsing agent.

15. The apparatus of claim 1 further comprising:
a user interface operably coupled to the control circuit.

16. The apparatus of claim 15 wherein the control circuit is configured to respond to at least some voice commands uttered by a user via the user interface.

17. The apparatus of claim 1 wherein the control circuit is configured to detect, via the at least one sensor, a presence of dishware in the sink.

18. The apparatus of claim 17 wherein the control circuit is further configured to, upon detecting at least a requisite quantity of the dishware in the sink, automatically employ the at least one articulated robotic arm to wash at least some of the dishware in the sink.

19. The apparatus of claim 1 further comprising:
a plurality of different end effectors;
and wherein the control circuit is further configured to automatically select a particular one of the plurality of different end effectors and attach the selected end effector to the end effector connector.

20. The apparatus of claim 1 wherein the control circuit is further configured to use the at least one articulated robotic arm to automatically place washed dishware in a drying area.
